(19) United States
(12) Patent Application Publication
(10) Pub. No.: US 2026/0044377 A1
(43) Pub. Date: Feb. 12, 2026

(54) MEDIA DATA PROCESSING METHOD, SYSTEM, DEVICE, AND STORAGE MEDIUM

(71) Applicant: Beijing Zitiao Network Technology Co., Ltd., Beijing (CN)

(72) Inventors: Kewei XIA, Beijing (CN); Huashan SU, Beijing (CN)

(21) Appl. No.: 19/290,535

(22) Filed: Aug. 5, 2025

(30) Foreign Application Priority Data
Aug. 6, 2024 (CN) 202411074687.3

(51) Int. Cl. G06F 9/50

(52) U.S. Cl. CPC G06F 9/5027

(57) ABSTRACT

The present disclosure provides a media data processing method, system, device, storage medium and product. The method includes: receiving, through a first server, a trigger request sent by a client after triggering any effect item for an image to be processed, creating, through the first server, an effect processing task, and performing pre-processing on the effect processing task and performing a judgement of a task execution condition; adding, through the first server, the effect processing task into a cache list readable by a second server after determining that the task execution condition is met based on a pre-processing result of the effect processing task; and accessing, through the second server, a processing server that performs effect processing, and transmitting the effect processing task obtained from the cache list to the processing server.

### CROSS-REFERENCE TO RELATED APPLICATION

This application claims the priority to and benefits of the Chinese Patent Application, No. 202411074687.3, which was filed on Aug. 6, 2024. The aforementioned patent application is hereby incorporated by reference in its entirety.

### TECHNICAL FIELD

Embodiments of the present disclosure relate to a media data processing method, a system, a device a storage medium and a product.

### BACKGROUND

Currently, image processing has been widely applied in daily life, and editing of various effects for an image can be achieved through an effect editing tool integrated in an image processing client. Due to such reasons as a wide variety of effect items in the effect editing tool available for image editing and large data processing models, not all algorithms involved in processing of each effect item can be integrated in the client. Thereby, in an existing implementation of effect editing for an image, after an effect item of the effect editing tool is triggered, a server containing algorithms for processing of the effect item can be accessed to implement editing of the image for the effect item.

### SUMMARY

Embodiments of the present disclosure provide a media data processing method, a system, a device, a storage medium and a product.

In a first aspect, the present disclosure provides a media data processing method, and the method includes:
receiving, through a first server, a trigger request sent by a client after triggering any effect item for an image to be processed, creating, through the first server, an effect processing task, and performing pre-processing on the effect processing task and performing a judgement of a task execution condition;
adding, through the first server, the effect processing task into a cache list readable by a second server after determining that the task execution condition is met based on a pre-processing result of the effect processing task; and
accessing, through the second server, a processing server that performs effect processing, and transmitting the effect processing task obtained from the cache list to the processing server.

In a second aspect, the present disclosure provides a media data processing system, and the system includes a client, a first server, a second server and a processing server,
the first server is configured to receive a trigger request sent by a client after triggering any effect item for an image to be processed, create an effect processing task, and perform pre-processing on the effect processing task, and perform a judgement of a task execution condition;
the first server is further configured to add the effect processing task into a cache list readable by a second server after determining that the task execution condition is met based on a pre-processing result of the effect processing task; and
the second server is configured to access a processing server that performs effect processing, and transmitting the effect processing task obtained from the cache list to the processing server.

In a third aspect, the present disclosure provides an electronic device, and the electronic device includes:
one or more processors; and
a storage apparatus, configured to store one or more programs;
when the one or more programs are executed by the one or more processors, the one or more processors are caused to implement the media data processing method as described in any embodiment of the present disclosure.

In a forth aspect, the present disclosure provides computer-readable storage medium having computer programs stored thereon, when the computer programs are executed by a processor, the method according to any embodiment of the present disclosure is implemented.

In a fifth aspect, the present disclosure further provides a computer program product, and the computer product includes computer programs, when the computer programs are executed by a processor, the method according to any embodiment of the present disclosure is implemented.

### BRIEF DESCRIPTION OF DRAWINGS

In conjunction with the accompanying drawings and referring to the specific implementations described below, the above and other features, advantages and aspects of embodiments of the present disclosure will become more apparent. Throughout the drawings, like or similar reference numerals denote like or similar elements. It should be understood that the drawings are illustrative only, and the original figures and elements are not necessarily drawn to scale.

FIG. 1 shows a flow diagram of a media data processing method provided by an embodiment of the present disclosure;

FIG. 2 shows a flow diagram of a media data processing method provided by an embodiment of the present disclosure;

FIG. 3 shows a structure diagram of a media data processing system provided by an embodiment of the present disclosure; and

FIG. 4 shows a structure diagram of an electronic device provided by an embodiment of the present disclosure.

### DETAILED DESCRIPTION

The embodiments of the present disclosure will be described in more detail below with reference to the accompanying drawings. Although certain embodiments of the present disclosure are shown in the accompanying drawings, it should be understood that the present disclosure can be implemented in various forms and should not be construed as being limited to the embodiments described herein. Instead, these embodiments are provided for a more thorough and complete understanding of the present disclosure. It should be understood that the drawings and embodiments of the present disclosure are only for exemplary purposes and are not intended to limit the scope of protection of the present disclosure.

It should be understood that the various steps described in the method implementation of the present disclosure can be performed in different orders and/or in parallel. In addition, the method implementation may include additional steps and/or omit the steps shown. The scope of the present disclosure is not limited in this respect.

The term “including” and its variations used herein are open inclusions, i.e., “including but not limited to”. The term “based on” is “based at least in part on”. The term “one embodiment” means “at least one embodiment”; the term “another embodiment” means “at least one other embodiment”; the term “some embodiments” means “at least some embodiments”. The relevant definitions of other terms will be given in the following description.

It should be noted that the concepts such as “first” and “second” mentioned in the present disclosure are only used to distinguish different devices, modules or units, and are not used to limit the order or interdependence of the functions performed by these devices, modules or units.

It should be noted that the modifications of “one” and “multiple” mentioned in the present disclosure are illustrative rather than restrictive. Those skilled in the art should understand that unless otherwise clearly stated in the context, they should be understood as “one or more”.

The names of the messages or information exchanged between multiple devices in the embodiments of the present disclosure are only for illustrative purposes, and are not used to limit the scope of these messages or information.

It can be understood that before using the technical solutions disclosed in the embodiments of the present disclosure, the type, scope of use, and usage scenarios of the personal information involved in the present disclosure should be informed to the user in an appropriate manner in accordance with relevant laws and regulations and the user's authorization should be obtained.

For example, in response to receiving an active request from the user, a prompt message is sent to the user to clearly prompt the user that the operation requested to be performed will require the acquisition and use of the user's personal information. Thereby, the user can autonomously choose whether to provide personal information to software or hardware such as electronic devices, applications, servers or storage media that perform the operations of the technical solutions of the present disclosure according to the prompt message.

As an optional but non-limiting implementation method, in response to receiving the user's active request, the method of sending prompt information to the user can be, for example, a pop-up window, and the prompt information can be presented in text form in the pop-up window. In addition, the pop-up window can also carry a selection control for the user to choose “agree” or “disagree” to provide personal information to the electronic device.

It can be understood that the above notification and the process of obtaining user authorization are only illustrative and do not constitute a limitation on the implementation method of the present disclosure. Other methods that meet relevant laws and regulations can also be applied to the implementation method of the present disclosure.

It can be understood that the data involved in this technical solution (including but not limited to the data itself, the acquisition or use of the data) shall comply with the requirements of relevant laws and regulations and relevant provisions.

It should be noted that image processing has been widely applied in daily life, and editing of various effects for an image can be achieved through an effect editing tool integrated in an image processing client. Due to such reasons as a wide variety of effect items in the effect editing tool available for image editing and large data processing models, not all algorithms involved in processing of each effect item can be integrated in the client; and the client is only responsible for presenting the image to facilitate human-computer interaction. When there is a need to add an effect to an image to be processed, it is necessary to download the corresponding effect from a backend server before processing. For example, when a template is selected for the image to be processed, the process of loading the template is essentially the process of processing the image by means of the backend server. Thereby, in an existing implementation of effect editing for an image, after an effect item of the effect editing tool is triggered, a server containing algorithms for processing of the effect item can be accessed to implement editing of the image for the effect item.

Generally, for the implementation of editing of the image for the effect item, the server can be allowed to process the image for the effect item only after a user with the need for processing the image has the permission to use the effect item. Currently, it is mainly up to the image processing client to determine whether the user has the permission. However, it is prone to using some special means on the image processing client to crack the limit on the permission for the effect item in the prior art, thereby leading to excessive consumption of processing resources and increased maintenance costs on the server.

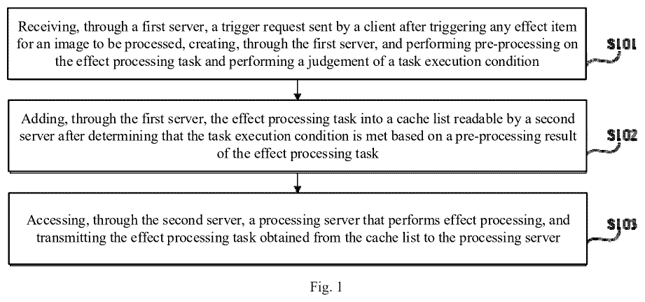

Thereby, an embodiment of the present disclosure provides a media data processing method, the method can effectively prevent special means and improve the task processing efficiency. FIG. 1 shows a flow diagram of a media data processing method provided by an embodiment of the present disclosure. The embodiment of the present disclosure is applicable to situations where processing of an effect is implemented on an image. This method can be executed by a media data processing system, which can be implemented in software and/or hardware form. Optionally, the system can be implemented through an electronic device, preferably a mobile terminal, a desktop, a laptop, a server, etc.

It can be known that the carrier executing the media data processing method provided in this embodiment can be integrated as a functional plug-in in an image processing application, or can be directly installed as application software on an electronic device.

As shown in FIG. 1, the media data processing method in the embodiment of the present disclosure may specifically include the following steps.

S101, receiving, through a first server, a trigger request sent by a client after triggering any effect item for an image to be processed, creating, through the first server, an effect processing task, and performing pre-processing on the effect processing task and performing a judgement of a task execution condition.

The application scenario of this embodiment can be described as follows: after login of the electronic device in which the media data processing method is integrated, the client on the electronic device will provide an image editing interface. In this embodiment, an image is used as media data to describe the process of executing the media data processing method. When the user wants to perform effect processing on the image to be processed, he can trigger the corresponding effect item on the client for editing of the corresponding effect.

Considering that only the link of the client and the processing server is used to process the image at present, it is prone to using some special means on the client to crack the limit on the permission for the effect item; and in this embodiment, a new link is provided for processing the image. This new link can be described as: two intermediate servers are added between the client and the processing server; and when an effect processing task is received, image processing is achieved by the two intermediate servers together with the client and the processing server.

The client is used to provide the user with an effect editing function for the image to be processed. The image to be processed can be understood as an image on which effect processing is desired to be performed. When the user needs to apply an effect to the image to be processed, any effect item for the image to be processed is triggered. The client generates a trigger request for the triggered effect item and transmits the trigger request to the first server. Upon receiving the trigger request, the first server can create a corresponding task for the effect item, which is referred to as an effect processing task in this embodiment. The first server assigns a unique task identification number to the effect processing task created by the client and feeds the task identification number back to the client so that the client can generate an effect query task or an effect cancellation task of the effect processing task by means of the task identification number.

In this embodiment, the first server may be a Hypertext Transfer Protocol (HTTP) server, which can communicate directly with the client and functions to interface with the client and for such logics as pre-processing and task execution condition determination. The second server may be a Remote Procedure Call (RPC) server, which can communicate with the processing server to invoke a processing model contained in the processing server. The first server and the second server have clear division of work, and the image processing efficiency can be improved through multi-server collaboration.

When a technical person configures the functions for image processing, corresponding configuration can be made on the first server. Information related to the configuration may include configuration for determining the permission of the user, configuration of the processing format required for the image to be processed, configuration about what kinds of processing are performed on the image, or configuration about what kinds of processing can be performed on the task processing result, etc. Processing model determination, processing permission determination, recognition of an image to be processed, format conversion of an image to be processed and processing completion notification are additionally added on the first server. For example, the first server can determine whether the effect processing task meets the task execution condition based on the added processing model determination and processing permission determination. Format conversion of an image to be processed and processing completion notification can be used for subsequent image processing. The first server performs pre-processing, which involves many pre-processing items that can be flexibly added or configured by the technical person during the development phase or the operation and maintenance phase. Further, in actual implementations, some of the pre-processing items can be configured in advance on the first server. The pre-processing items include but are not limited to those listed above, and can also be dynamically expanded on the first server according to actual needs.

When the effect processing task is created, it will be firstly sent to the first server for pre-processing, and it is determined whether the effect processing task meets the task execution condition based on the pre-processing result. If the effect processing task meets the task execution condition, then subsequent processing of the link will continue to be performed. If the effect processing task does not meet the task execution condition, then subsequent processing of the link will not continue to be performed any more, which can also be understood as that effect processing is not performed any more on the image to be processed. When pre-processing is performed on the effect processing task, the effect processing task can be determined based on a related processing item of the pre-configured pre-processing items. For example, if the pre-processing items include processing permission determination and recognition of an image to be processed, then whether the effect processing task meets the task execution condition can be determined based on the two pre-processing items.

S102, adding, through the first server, the effect processing task into a cache list readable by a second server after determining that the task execution condition is met based on a pre-processing result of the effect processing task.

The second server can be specifically understood as an additional server added between the client and the processing server. For example, the second server can use the RPC protocol to communicate with the processing server. The cache queue readable by the second server contains other effect processing tasks to be processed. In this embodiment, after it is determined that the task execution condition is met based on a pre-processing result of the effect processing task, there is a need to write the effect processing task into the second server through the first server and add the effect processing task into the cache list readable by the second server.

S103, accessing, through the second server, a processing server that performs effect processing, and transmitting the effect processing task obtained from the cache list to the processing server.

According to the above description, this step is used for consuming the effect processing task in the cache list. Specifically, the second server accesses the processing server for effect processing, obtains the effect processing task from the cache list, and transmits the effect processing task to the processing server.

It should be understood that the processing server is used for processing the effect processing task. When processing the effect processing task, the processing server can process the effect processing task according to the information determined in the pre-processing so as to obtain the processing result of the effect processing task. When the image to be processed is processed, the effect processing task needs to be transmitted through the client, the first server and the second server sequentially to the processing server, and it is the processing server that performs the effect processing task. Correspondingly, after the processing result of the effect processing task is obtained, it needs to be fed back through the processing server, the second server and the first server sequentially to the client, which then presents the processing result to the user.

As compared to the method used at present in which the client is used to determine whether the user has the permission to use the effect item, in the media data processing method provided by the embodiment of the present disclosure, the first server and the second server are additionally provided as intermediate servers between the client and the processing server to participate in the image processing process so that the first server is used instead of the client to determine whether the user has the permission to use the effect item, thereby avoiding using some special means to crack the permission for the effect item. As compared to the method used at present in which the special means cannot be avoided on the client, the special means can be effectively avoided on the servers through such a chain of the client, the first server, the second server and the processing server. Meanwhile, in the method used at present, when multiple images to be processed are being processed, one task needs to be completed before next task proceeds, leading to that the tasks wait synchronously and take a long time; and by comparison, in this technical solution, the tasks can be placed at the backend servers for processing while a new task can be processed at the frontend client, which reduces the time and cost for processing the tasks and improves the task processing efficiency.

As a first optional embodiment of this embodiment, on the basis of the above embodiment, the step of performing pre-processing and task execution condition determination on the effect processing task can be optimized, which may include the following steps.
a1) determining a target pre-processing item corresponding to the effect processing task from pre-processing items that are pre-configured and performing processing of the target pre-processing item, the pre-processing items are pre-configured on the first server and the pre-processing items includes: processing model determination, processing permission determination, recognition of an image to be processed, format conversion of an image to be processed, and configuration of processing completion notification.

In the first optional embodiment, when the technical person configures the functions for image processing, corresponding configuration can be made on the first server. Processing model determination, processing permission determination, recognition of an image to be processed, format conversion of an image to be processed and processing completion notification, which are referred to as pre-processing items in the pre-processing stage, are additionally added on the first server. The first server performs pre-processing, which involves many pre-processing items that can be flexibly added or configured by the technical person during the development phase or the operation and maintenance phase. Further, in actual implementations, some of the pre-processing items can be configured in advance on the first server. The pre-processing items are not limited to those listed above, and can also be dynamically expanded on the first server according to actual needs.

It should be noted that, each time the effect processing task is executed, the involved effect processing model for the effect item associated with the effect processing task is determined, and corresponding processing model configuration parameters are obtained. Although the effect processing model is determined on the first server, the corresponding processing model configuration parameters can be associated as information with the effect processing task and transmitted downstream. The effect processing model can be understood as an algorithmic model for processing the image to be processed.

In this embodiment, this pre-processing item of processing model determination is required each time the effect processing task is executed. However, these pre-processing items of processing permission determination, recognition of an image to be processed, format conversion of an image to be processed and processing completion notification can be used as optional items, and set according to whether these requirements are needed in different actual scenarios.

For example, for processing permission determination, different information can be configured depending on different scenarios. In a scenario, it may be free limited access, where the number of times is configurable. For example, it supports subscription-based membership or one-time purchase, and the logic to limit the number of times each time can be implemented through other servers. The user is also guided to share the functions to attract new users so as to increase the number of usage times. Moreover, it supports storing data based on multiple dimensions such as daily/monthly usage counts and historical task counts. In another scenario, it may involve “VIP member-limited access”, where the number of times is configurable. In yet another scenario, it is single-purchase access. For example, if the effect items can be divided into free items and paid items, and the paid items are further divided into limited-free items and non-limited-free items, then it is necessary to pre-configure which effect items are free items, which are limited-free items, and what's the number of times for the limited-free items. The above information is used as pre-configuration items, and processing permission determination for the user can be performed based on the information.

Recognition of an image to be processed can be understood as recognizing whether the image to be processed meets the requirement for effect processing, e.g., whether its format or size meets the requirement. Format conversion of an image to be processed can be understood as what kind of format conversion is performed on the image to be processed. During pre-processing, when being uploaded from the client, an image format having similar quality but a smaller volume can be uploaded as the image to be processed, thus saving the transmission bandwidth. When the image is transmitted to a downstream algorithm for processing, it will then be converted into an image format compatible with the algorithm. For example, format conversion between AVIF and JPG can be provided, and uploading an image to be processed with the AVIF format from the client can save the bandwidth. Correspondingly, the image to be processed should be firstly converted into the compatible JPG format suitable for the downstream algorithm before it is transmitted to the processing server by the second server. It should be understood that it is difficult to implement image format conversion in the existing link. However, through the link provided by this embodiment, image format conversion can be easily implemented based on the added servers.

In this embodiment, through the above configuration of the pre-processing items, different determination conditions, different determination criteria and what kind of processing can be done to the image can be set. Based on different determination conditions and criteria, it can be determined whether the effect processing task meets the task execution condition.

In this step, the pre-processing item corresponding to the effect processing task, which is referred to as the target pre-processing item, is determined from the pre-configured pre-processing items, and the target pre-processing item is processed to obtain the processing result. For example, if the target pre-processing item corresponding to an effect processing task is processing model determination and processing permission determination, it will be determined whether the user using this effect processing task has the permission and whether the number of uses for the user has reached the maximum allowed number of uses, i.e., it will be determined based on the pre-configured information.
b1) determining whether the effect processing task meets the task execution condition according to a pre-processing result of the target pre-processing item.

In this embodiment, the target pre-processing item is processed to obtain a processing result, which is referred to as the pre-processing result. Based on the pre-processing result, it is determined whether the effect processing task meets the task execution condition. Only when the pre-processing result meets the task execution condition will the effect processing task continue to be passed downstream. For the pre-processing result of the target pre-processing item, only when all the processing results contained in the pre-processing result pass can it be considered that the effect processing task meets the task execution condition.

Consider that the processing server provides services for a series of software products involved in different software developers. The processing server is essentially the provider of unified resources. If a specific product is optimized or modified in function, the entire processing server will be optimized, leading to time-consuming and less effective optimization, high customized logic costs and limited optimization methods; and when there are different product requirements, the processing server will be developed differently. In view of the above problem, by adding the first server and the second server, providing optimized configuration of the required functions on the first server and setting the pre-processing items in this embodiment, the technical person can customize the configuration of the pre-processing items according to actual needs, thereby achieving customized optimization, avoiding limitations in optimization methods (e.g., customized logic for the return image format and the return data structure), and saving the customized logic costs.

In the technical solution of the first optional embodiment, the step of performing pre-processing and task execution condition determination on the effect processing task is specifically described. By adding the first server on which the user's permission is determined, it can be avoided to use some special means to crack the permission for the effect item. At the same time, by configuring the pre-processing items on the first server, it provides a basis for determining the user's permission and processing the image, and facilitates customized optimization for software developers, thereby avoiding setting the additional customized logic and saving the costs.

As one of the implementations, in the first optional embodiment, the step of determining whether the effect processing task meets the task execution condition according to the pre-processing result of the target pre-processing item can be further specified in the following steps.
b11) when the target pre-processing item includes the processing permission determination and the recognition of an image to be processed, in response to a corresponding pre-processing result being that processing is allowed and image recognition is passed, determining that the effect processing task meets the task execution condition.

Specifically, when the target pre-processing item includes processing permission determination and recognition of an image to be processed, it needs to use the results of both processing permission determination and recognition of an image to be processed to determine whether the effect processing task meets the task execution condition. If the corresponding pre-processing result is that processing is allowed and image recognition is passed, i.e., the number of uses for the user has not yet exceeded the threshold, and the image to be processed meets the processing requirement, then it is determined that the effect processing task meets the task execution condition.

If the corresponding pre-processing result is that processing is not allowed or image recognition is not passed, i.e., the number of uses for the user has exceeded the threshold, or the image to be processed does not meet the processing requirement, then it is determined that the effect processing task does not meet the task execution condition.
b12) when the target pre-processing item includes the processing permission determination or the recognition of an image to be processed, in response to the pre-processing result being that processing is allowed or image recognition is passed, determining that the effect processing task meets the task execution condition.

Specifically, when the target pre-processing item includes processing permission determination, it only needs to use the result of processing permission determination to determine whether the effect processing task meets the task execution condition. If the pre-processing result is that processing is allowed, i.e., the number of uses for the user has not yet exceeded the threshold, then it is determined that the effect processing task meets the task execution condition. When the target pre-processing item includes recognition of an image to be processed, it only needs to use the result of recognition of an image to be processed to determine whether the effect processing task meets the task execution condition. If the pre-processing result is that image recognition is passed, i.e., the image to be processed meets the processing requirement, then it is determined that the effect processing task meets the task execution condition.

In the above technical solution of this embodiment, the step of determining whether the effect processing task meets the task execution condition according to the pre-processing result is described specifically. Whether the effect processing task meets the task execution condition is determined on the first server according to the pre-processing result. The first server is used instead of the client to determine whether the user has the permission, thereby avoiding using some special means to crack the permission for the effect item.

In the above embodiment, there is described as follows: when it is desired to perform effect processing on the image to be processed, the client creates the effect processing task through triggering of the effect item, and the effect processing task is transmitted through the first server and the second server to the processing server. After the effect processing task is transmitted to the processing server, what kinds of processing need to be performed on the effect processing task by the processing server and how to feed the processing result back to the client will be described in the following optional embodiment.

As a second optional embodiment of this embodiment, on the basis of the above embodiment, the method can further include the following steps.
a2) calling a matching processing model according to a processing model configuration parameter determined in the pre-processing to process the effect processing task through the processing server, and saving a task processing result.

In the second optional embodiment, the processing server processes the effect processing task to obtain the processing result, which is referred to as the task processing result, and saves it. The processing model configuration parameter is a parameter obtained when processing model determination is performed on the first server, which is referred to as the processing model configuration parameter. The processing model configuration parameter will ultimately be transmitted to the processing server. When the processing server processes the effect processing task, it needs to firstly call the matching processing model according to the processing model configuration parameter determined in the pre-processing and process the effect processing task based on the matching processing model.
b2) performing post-processing on the task processing result read according to a preset post-processing strategy through the second server, and recording the task processing result that is post-processed into a data center.

In this embodiment, after the task processing result is saved, it is needed to feed the task processing result back to the client. The link for feeding the task processing result back to the client can be described as follows: the effect processing task obtained through processing by the processing server is fed back to the client via the second server and the first server. This step is used to describe what operations the second server needs to perform on the task processing result. First, the second server reads the task processing result, then performs post-processing on the read task processing result, and finally records the post-processed task processing result into the data center. After the task processing result is obtained by the processing server, it is first acquired by the second server which performs some post-processing on it.

In this optional embodiment, after post-processing is performed on the read task processing result by the second server, the post-processed task processing result is recorded into the data center. On the first server, there are some processing items for the post-processing stage which are pre-configured during the pre-processing phase. These processing items are information that can be additionally added or configured, and some corresponding processing items can be additionally added as long as the processed image needs to be further processed. Post-processing may vary when different tasks are processed. As an example, if it is an effect query task, the server may feed back information that can only be recognized by the technical person, and the information can be converted into readable and visible information for the client through post-processing. As another example, post-processing may be generating a corresponding notification message for the processing result, the second server generates a corresponding notification, and the transmission of the notification message is informed to the client by the first server. During the pre-processing phase, the first server may be pre-configured with the notification form, i.e., the notification message is configured on the first server and the corresponding notification message is generated on the second server. Post-processing includes but is not limited to the above processing methods.
c2) feeding the task processing result obtained from the data center back to the client through the first server; or, sending a processing completion notification to the client, and feeding the task processing result obtained from the data center back to the client after receiving a view request from the client.

In this optional embodiment, the first server can receive a task from the client, be connected with the second server, and directly access the data center. There are two ways to return the task processing result to the client. In one way, the first server accesses the data center to obtain the task processing result from the data center and feed the task processing result back to the client.

In the other way, if the notification is configured in advance, the first server sends to the client the processing completion notification indicating the task processing has been completed, and the client can send the view request to the first server after receiving the processing completion notification. Accordingly, after receiving the view request from the client, the first server obtains the task processing result corresponding to the view request from the data center and feeds the task processing result back to the client.

In this optional embodiment, the processing completion notification may be either an in-site notification or an out-of-site notification. The in-site notification can be understood as a notification transmitted when the user has not left the client during processing of the effect processing task. The out-of-site notification can be understood as a notification transmitted when the user leaves the interface of the client for processing the image to be processed or directly leaves the client during execution of the effect processing task. If the user has not left the client during processing of the effect processing task, the first server will transmit the in-site notification to the client, and the in-site notification is presented on the interface of the client. For example, if the user remains in the image editing software without exiting during execution of the effect processing task, the backend server performs the effect processing task, and some other processing operations such as retouching other images to be processed can be performed, then the in-site notification for the effect processing task can be received. If the user leaves the client during processing of the effect processing task, the first server will transmit the out-of-site notification to the client. Additionally, both in-site and out-of-site notifications can be set to remind the user, e.g., displaying the out-of-site notification in the notification bar and transmitting the in-site notification in the message center of the image editing software.

It should be understood that, the processing completion notification is configured during the pre-processing stage whether it is the in-site notification or the out-of-site notification. Configuration of the notification may include: whether to make a notification, what's the form of the notification, etc. Specifically, the processing completion notification is generated by the second server during the post-processing stage.

In the above technical solution of the second optional embodiment, the step of how to feed the effect processing task processed by the processing server back to the client through the second server and the first server is additionally added to realize the whole process of image processing.

As one of the implementations, in the second optional embodiment, the step of feeding the task processing result obtained from the data center back to the client can be further specified in the following steps.
c21) obtaining a task processing result corresponding to the effect processing task from the data center, encrypting the task processing result, and feeding an encrypted processing result back to the client.

In this embodiment, before the effect processing task is processed, the first server first performs task execution condition determination to avoid using special means to crack the limit on the permission for the effect item. In addition, when the task processing result is returned to the client, further verification is performed on the client. In this step, the client is further verified based on encryption and decryption of the task processing result. This encryption configuration is also configured by the first server in the pre-configured items. Specifically, the processing server obtains the task processing result through processing and stores it into the data center. The first server obtains the task processing result corresponding to the effect processing task from the data center and encrypts the task processing result based on the encryption configuration in the pre-configured items so as to obtain the encrypted processing result, which is then fed back to the client.
c22) after receiving a decryption request for the encrypted processing result from the client, in response to determining that the client meets a decryption permission, calling an independent decryption interface corresponding to the encrypted processing result to perform decryption, and transmitting a decrypted decryption result back to the client.

It should be understood that after the client obtains the encrypted processing result which is an encrypted generation result graph, the client needs to transmit a decryption request for the encrypted processing result to the first server in order to obtain the task processing result before encryption. Upon receiving the decryption request for the encrypted processing result from the client, the first server will verify the permission of the client. If it is determined that the client meets the decryption permission, the independent decryption interface corresponding to the encrypted processing result will be called for decryption so as to obtain the decrypted result, which is transmitted back to the client. If it is determined that the client does not meet the decryption permission, the encrypted processing result will not be decrypted, and accordingly, the client will not obtain the task processing result.

The above technical solution gives the step of feeding the task processing result obtained from the data center back to the client. When the task processing result is fed back to the client, the permission of the client is further verified, thereby avoiding using special means to obtain the task processing result and bypass the verification.

As a third optional embodiment of this embodiment, on the basis of the above embodiment, the method can further include the following step:
Uploading, through the first server, the task processing result obtained from the data center to an image processing platform that is deployed through the first server, obtaining upload information, accessing the image processing platform based on the upload information, receiving a secondary processing result obtained after the image processing platform performs secondary processing on the task processing result, and transmitting the secondary processing result back to the client.

In the third optional embodiment, the function of performing secondary processing on the task processing result is added. Through the first server, the task processing result is obtained from the data center and uploaded to the deployed image processing platform. The image processing platform can be understood as a platform for processing an image, e.g., sharpening the image, adjusting contrast, adding a watermark, etc. In this embodiment, uploading the task processing result to the image processing platform will get link information for accessing the image processing platform, which is referred to as the upload information. For example, the upload information may be the Uniform Resource Location (URL), which is a representation used on the World Wide Web service program of the Internet to specify the location of information.

According to the above description, after the first server uploads the task processing result to the image processing platform, the image processing platform performs processing on the task processing result according to the post-processing request initiated by the first server, and obtains the processing result (referred to as the secondary processing result), with the processing being considered as secondary processing, e.g., sharpening the task processing result, adjusting contrast, adding a watermark, etc. The first server can access the image processing platform through the upload information and receive the secondary processing result obtained after the image processing platform performs secondary processing on the task processing result. The first server can also transmit the secondary processing result back to the client for display as the task processing result.

In the above technical solution of the third optional embodiment, the function of performing secondary processing on the task processing result is added to realize the diversity of image processing.

It should be known that the client is directly connected with the processing server in the prior art. The client passively waits for feedback for the effect processing task from the processing server, which may either be a correct processing result or a timeout or error prompt. However, if the feedback is a timeout or error prompt, it often contains some codes that a non-technical person cannot understand, leading to poor readability and visibility. For example, when a timeout or failure rate alert occurs, the client directly interfaces with the processing server and the algorithm model, and there are obstacles in understanding technical stacks and terminology concepts, resulting in a low troubleshooting efficiency. In view of this problem, the fourth optional embodiment below solves it by additionally adding the first server and the second server.

As the fourth optional embodiment of this embodiment, on the basis of the above embodiment, the method can further include the following steps.
a3) receiving, through the first server, an effect query task sent by the client after creating the effect processing task through the first server, and transmitting the effect query task to the second server.

The effect query task can be understood as a query task related to the effect progress. In this embodiment, after the client creates the effect processing task, the client periodically transmits the effect query task during processing of the effect processing task. The first server receives the effect query task from the client, and transmits the effect query task to the second server which performs secondary processing on the feedback result.
b3) sending, through the second server, a processing progress query request to the processing server based on the effect query task received receiving a progress query result fed back from the processing server and organizing the progress query result into visual query information.

According to the above description, the second server receives the effect query task from the first server, and transmits the processing progress query request to the processing server based on the effect query task. After receiving the processing progress query request, the processing server feeds the progress query result back to the second server, which further processes the progress query result and organizes it into the visual query information. The visual query information can be understood as task progress information that is easy for the user to read and view. For example, the visual query information may include the current progress and the current time consumption, and they can be represented by using pictures, text etc., which are not limited here.
c3) feeding the visual query information back to the client through the first server for presentation.

Specifically, the first server feeds the visual query information back to the client to be presented to the user. It can be understood that the client periodically transmits the effect query task and the first server also periodically feeds the visual query information back to the client.

In the above technical solution of the fourth optional embodiment, the first server and the second server that are additionally added perform secondary processing on the progress query result, which is fed back to the client in the form of the visual query information. This ensures that the user of the client can directly understand the progress query result, avoiding obstacles in understanding the professional terms when the user performs the effect progress query, thereby improving the troubleshooting efficiency.

As a fifth optional embodiment of this embodiment, on the basis of the above embodiment, the method can further include the following steps.
a4) receiving, through the first server, an effect cancellation task sent by the client after creating the effect processing task through the first server, and transmitting the effect cancellation task to the second server.

In the fifth optional embodiment, the function of canceling the effect processing task can also be implemented. The task of canceling the effect processing task is referred to as the effect cancellation task. Specifically, when the user wants to cancel the effect processing task, the client transmits the effect cancellation task to the first server. Upon receiving the effect cancellation task, the first server transmits it to the second server.
b4) transmitting the effect cancellation task to the processing server through the second server, receiving a response result for the effect cancellation task from the processing server and transmitting the response result back to the first server.

Specifically, after receiving the effect cancellation task, the second server transmits it to the processing server. Upon receiving the effect cancellation task, the processing server responds to the effect cancellation task, i.e., stops the effect processing model from processing the image to be processed. The processing server transmits the response result for the effect cancellation task back to the first server.
c4) transmitting the response result back to the client through the first server so that the client exits presentation state of effect processing according to the response result.

In this embodiment, the first server transmits the response result back to the client, which is equivalent to that the processing server cancels the effect processing task successfully. Then, the client exits the presentation state of effect processing according to the response result.

The above technical solution of the fifth optional embodiment specifies the execution process of the effect cancellation task and realizes the function of canceling the effect processing task.

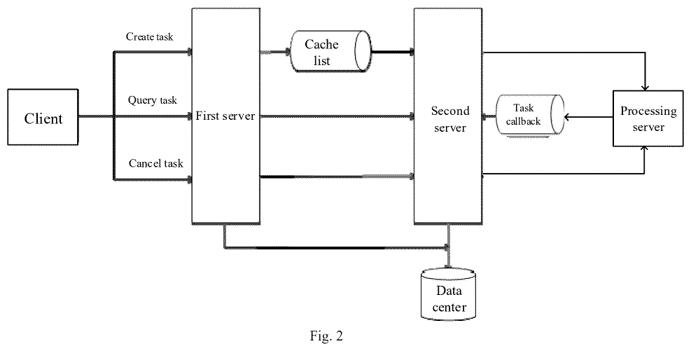

To more clearly illustrate the execution chain of the media data processing method provided by the embodiment of the present disclosure, FIG. 2 shows a flow diagram of a media data processing method provided by an embodiment of the present disclosure. As shown in FIG. 2, the client can create an effect processing task to the first server, query the progress of the effect processing task, or cancel the effect processing task. For creation of the effect processing task, the first server stores the effect processing task into a cache list of the second server; the processing server obtains the effect processing task from the cache list, which is transmitted to the processing server for processing; after processing the effect processing task, the processing server obtains a task processing result; the second server performs post-processing on the read task processing result, and records the post-processed task processing result into a data center; and the first server feeds the task processing result obtained from the data center back to the client. For query of the effect processing task, the client transmits a query task through the first server, the second server and the processing server sequentially; and the processing server makes a response, which is fed back to the client through the second server and the first server. Similarly, for cancellation of the effect processing task, it is also transmitted through the first server, the second server and the processing server; and the processing server makes a response, which is fed back to the client through the second server and the first server. Image processing is achieved through collaboration among the client, the first server, the second server and the processing server.

As a sixth optional embodiment of this embodiment, on the basis of the above embodiment, the method can further include the following steps.
a5) summarizing, through the first server, effect processing tasks received within a set time period, and determining a total number of triggering times for effect items associated with the effect processing tasks within the set time period.

Considering that hotspot monitoring can provide a basis for operational decisions, the existing image processing chain lacks hotspot monitoring. To implement hotspot monitoring, an additional set of logic is required to realize the hotspot monitoring function, leading to higher construction costs. In view of this problem, the link provided by the sixth optional embodiment can realize the hotspot monitoring function. The client triggers different effect items to generate different effect processing tasks, which are transmitted to the first server. The first server summarizes the effect processing tasks received within the set time, and counts the total number of times the effect items associated with the different effect processing tasks are triggered within the set time.
b5) marking an effect item of which a total number of triggering times is higher than a set threshold as a hotspot effect item through the first server.

Specifically, based on the first server, the effect item of which the number of triggers is higher is marked as the hotspot effect item. For example, the effect item of which the total number of triggers is higher than the set threshold is marked as the hotspot effect item; or the effect items are ranked in terms of the total number of triggers, with the top-ranked effect item being considered as the hotspot effect item.

In the above technical solution of the sixth optional embodiment, the hotspot monitoring function for the effect items is added based on the image processing link with the first server and the second server additionally provided. The hotspot monitoring function can be realized without additional logic, thus saving construction costs and providing a basis for operational decisions.

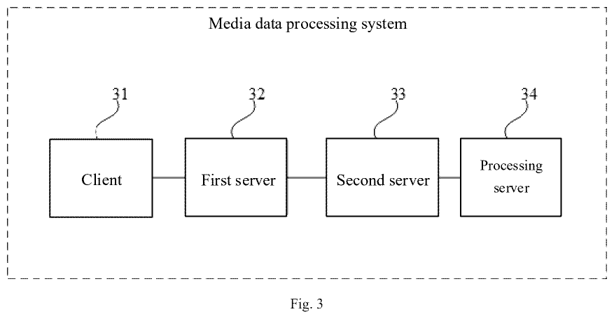

FIG. 3 shows a structure diagram of a media data processing system provided by an embodiment of the present disclosure. As shown in FIG. 3, the system may include a client 31, a first server 32, a second server 33, and a processing server 34.

The first server 32 is configured to receive an effect processing task created by the client 31 for a trigger request transmitted after any effect item is triggered for an image to be processed, and perform pre-processing on the effect processing task, and perform a judgement of a task execution condition.

The first server 32 is further configured to add the effect processing task into a cache list readable by a second server after determining that the task execution condition is met based on a pre-processing result of the effect processing task.

The second server 33 is configured to access a processing server that performs effect processing, and transmitting the effect processing task obtained from the cache list to the processing server.

As compared to the method used at present in which the client is used to determine whether the user has the permission to use the effect item, in the media data processing system provided by the embodiment of the present disclosure, the first server and the second server are additionally provided as intermediate servers between the client and the processing server to participate in the image processing process so that the first server is used instead of the client to determine whether the user has the permission to use the effect item, thereby avoiding using some special means to crack the permission for the effect item. As compared to the prior art in which the special means cannot be avoided on the client, the special means can be effectively avoided on the servers through such a chain of the client, the first server, the second server and the processing server. Meanwhile, in the prior art, when multiple images to be processed are being processed, one task needs to be completed before next task proceeds, leading to that the tasks wait synchronously and take a long time; and by comparison, in this technical solution, the tasks can be placed at the backend servers for processing while a new task can be processed at the frontend client, which reduces the time for processing the tasks and improves the task processing efficiency.

Further, the first server 32 is configured to the step of performing pre-processing on the effect processing task and performing a judgement of a task execution condition, and the step may include:
determining a target pre-processing item corresponding to the effect processing task from pre-processing items that are pre-configured and performing processing of the target pre-processing item, the pre-processing items are pre-configured on the first server and the pre-processing items includes: processing model determination, processing permission determination, recognition of an image to be processed, format conversion of an image to be processed, and configuration of processing completion notification; and
determining whether the effect processing task meets the task execution condition according to a pre-processing result of the target pre-processing item.

Further, the determining whether the effect processing task meets the task execution condition according to a pre-processing result of the target pre-processing item includes:
when the target pre-processing item includes the processing permission determination and the recognition of an image to be processed, in response to a corresponding pre-processing result being that processing is allowed and image recognition is passed, determining that the effect processing task meets the task execution condition; and
when the target pre-processing item includes the processing permission determination or the recognition of an image to be processed, in response to the pre-processing result being that processing is allowed or image recognition is passed, determining that the effect processing task meets the task execution condition.

Further, the processing server 34 is configured to call a matching processing model according to a processing model configuration parameter determined in the pre-processing to process the effect processing task through the processing server, and save a task processing result;
the second server 33 is further configured to perform post-processing on the task processing result read according to a preset post-processing strategy through the second server, and record the task processing result that is post-processed into a data center; and
the first server 32 is further configured to feed the task processing result obtained from the data center back to the client 31 through the first server; or, sending a processing completion notification to the client 31, and feed the task processing result obtained from the data center back to the client 31 after receiving a view request from the clien31t 31.

Further, the first server 31 is configured to execute the step of feeding the task processing result obtained from the data center back to the client, and the step may include:
obtaining a task processing result corresponding to the effect processing task from the data center, encrypting the task processing result, and feeding an encrypted processing result back to the client; and after receiving a decryption request for the encrypted processing result from the client, in response to determining that the client meets a decryption permission, calling an independent decryption interface corresponding to the encrypted processing result to perform decryption, and transmitting a decrypted decryption result back to the client.

Further, the first server 32 uploads, through the first server, the task processing result obtained from the data center to an image processing platform that is deployed through the first server, obtain upload information, access the image processing platform based on the upload information, receive a secondary processing result obtained after the image processing platform performs secondary processing on the task processing result, and transmit the secondary processing result back to the client.

Further, the first server 32 is further configured to receive, through the first server, an effect query task sent by the client after creating the effect processing task through the first server, and transmitting the effect query task to the second server 33;
the second server 33 is further configured to send, through the second server, a processing progress query request to the processing server based on the effect query task received, receive a progress query result fed back from the processing server 34 and organize the progress query result into visual query information; and
the first server 32 is further configured to feed the visual query information back to the client through the first server for presentation.

Further, the first server 32 is further configured to receive, through the first server, an effect cancellation task sent by the client 31 after creating the effect processing task through the first server, and transmit the effect cancellation task to the second server;
the second server 33 is further configured to transmit the effect cancellation task to the processing server through the second server, receive a response result for the effect cancellation task from the processing server and transmitting the response result back to the first server; and
the first server 32 is further configured to transmit the response result back to the client through the first server so that the client exits presentation state of effect processing according to the response result.

Further, the first server 32 is further configured to summarize, through the first server, effect processing tasks received within a set time period, and determining a total number of triggering times for effect items associated with the effect processing tasks within the set time period; and
the first server 32 is further configured to mark an effect item of which a total number of triggering times is higher than a set threshold as a hotspot effect item through the first server.

The media data processing system provided by the embodiment of the present disclosure can execute the media data processing method provided by any embodiment of the present disclosure, and has functional modules and beneficial effects corresponding to the execution method.

It is worth noting that the units and modules included in the above system are only divided according to the functional logic, but are not limited to the above division as long as the corresponding functions can be realized. In addition, the specific names of the functional units are only for the convenience of mutual differentiation, but are not used to limit the scope of protection of the embodiments of the present disclosure.

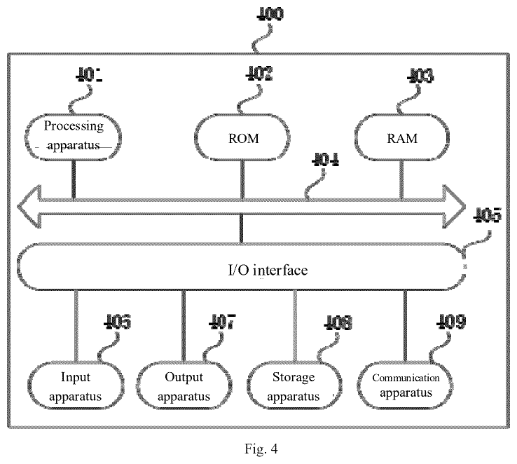

FIG. 4 shows a structure diagram of an electronic device provided by an embodiment of the present disclosure. Referring to FIG. 4 below, it shows a structure diagram of an electronic device (e.g., a terminal device or a server in FIG. 4) 400 suitable for implementing the embodiment of the present disclosure. The terminal devices in the embodiment of the present disclosure may include but are not limited to mobile terminals such as mobile phones, laptops, digital radio receivers, Personal Digital Assistants (PDAs), Portable Android Devices (PADs), Portable Multimedia Players (PMPs), and in-vehicle terminals (e.g., in-vehicle navigation terminals), as well as fixed terminals such as digital TVs and desktop computers. The electronic device shown in FIG. 4 is merely an example and should not be construed as limiting the functions and scope of use of the embodiment of the present disclosure.

As shown in FIG. 4, the electronic device 400 may include a processing apparatus (e.g., a central processing unit, a graphics processor, etc.) 401, which can perform various appropriate actions and processes according to programs stored in a read-only memory (ROM) 402 or programs loaded from a storage apparatus 408 to a random-access memory (RAM) 403. In the RAM 403, various programs and data required for the operation of the electronic device 400 are also stored. The processing apparatus 401, the ROM 402, and the RAM 403 are connected to each other via a bus 404. An input/output (I/O) interface 405 is also connected to the bus 404.

Generally, the following apparatuses can be connected to the I/O interface 405: an input apparatus 406 such as a touchscreen, a touchpad, a keyboard, a mouse, a camera, a microphone, an accelerometer and a gyroscope; an output apparatus 407 such as a liquid crystal display (LCD), a speaker and a vibrator; a storage apparatus 408 such as a tape and a hard drive; and a communication apparatus 409. The communication apparatus 409 allows the electronic device 400 to communicate with other devices in a wireless or wired way to exchange data. Although FIG. 4 shows the electronic device 400 with various apparatuses, it should be understood that not all of the shown apparatuses are required to be implemented or possessed. Alternatively, more or fewer apparatuses may be implemented or possessed.

Specifically, according to the embodiment of the present disclosure, the process described above with reference to the flowchart can be implemented as a computer software program. For example, an embodiment of the present disclosure includes a computer program product, which includes a computer program carried on a non-transitory computer-readable medium. The computer program includes a program code for executing the method shown in the flowchart. In such embodiments, the computer program can be downloaded and installed from the network via the communication apparatus 409, installed from the storage apparatus 408, or installed from the ROM 402. When the computer program is executed by the processing apparatus 401, it performs the above functions defined in the method of the embodiment of the present disclosure.

The names of messages or information exchanged between multiple apparatuses in the implementations of the present disclosure are used only for illustrative purposes, but are not intended to limit the scope of the messages or information.

The electronic device provided by this embodiment of the present disclosure and the media data processing method provided by the above embodiments belong to the same inventive concept, so reference can be made to the above embodiments for the technical details that are not described in detail in this embodiment. Moreover, this embodiment has the same beneficial effects as the above embodiments.

An embodiment of the present disclosure provides a computer storage medium, which has a computer program stored thereon. When being executed by a processor, the program implements the media data processing method provided in the above embodiments.

It should be noted that the computer-readable medium described above in the present disclosure may be a computer-readable signal medium, a computer-readable storage medium, or any combination of both. For example, the computer-readable storage medium may be but is not limited to an electrical, magnetic, optical, electromagnetic, infrared or semiconductor system, apparatus or component, or any combination thereof. More specific examples of the computer-readable storage medium may include, but are not limited to: electrical connections with one or more wires, portable computer disks, hard drives, random access memories (RAMs), read-only memories (ROMs), erasable programmable read-only memories (EPROMs or flashes), optical fibers, portable compact disk read-only memories (CD-ROMs), optical storage components, magnetic storage components, or any suitable combination thereof. In the present disclosure, the computer-readable storage medium may be any tangible medium containing or storing a program, and the program can be used by or in connection with an instruction execution system, apparatus or component. In the present disclosure, the computer-readable signal medium may include a data signal propagated in the baseband or as part of a carrier, and the computer-readable program code is carried in the data signal. This propagated data signal may take various forms, including but not limited to an electromagnetic signal, an optical signal, or any suitable combination thereof. The computer-readable signal medium may also be any computer-readable medium other than the computer-readable storage medium. The computer-readable signal medium can send, propagate or transmit a program that is for use by or in connection with the instruction execution system, apparatus or component. The program code contained on the computer-readable medium can be transmitted using any suitable medium, including but not limited to wire, an optical fiber, radio frequency (RF), or any suitable combination thereof.

In some implementations, the client and the server can communicate using any currently known or future-developed network protocol such as the HyperText Transfer Protocol (HTTP), and can be interconnected with digital data communication of any form or medium (e.g., communication networks). Examples of the communication networks include Local Area Networks (“LANs”), Wide Area Networks (“WANs”), internetworks (e.g., the Internet), and peer-to-peer networks (e.g., ad hoc peer-to-peer networks), as well as any currently known or future-developed networks.

The above computer-readable medium may be contained in the above electronic device, or may exist separately and not be assembled in the electronic device.

The above computer-readable medium carries one or more programs. When the one or more programs are executed by the electronic device, the electronic device performs the following steps: receiving, through a first server, a trigger request sent by a client after triggering any effect item for an image to be processed, creating, through the first server, an effect processing task, and performing pre-processing on the effect processing task and performing a judgement of a task execution condition; adding, through the first server, the effect processing task into a cache list readable by a second server after determining that the task execution condition is met based on a pre-processing result of the effect processing task; and accessing, through the second server, a processing server that performs effect processing, and transmitting the effect processing task obtained from the cache list to the processing server.

The computer program code for performing the operations of the present disclosure can be written in one or more programming languages or any combination thereof. The one or more programming languages include but are not limited to object-oriented programming languages such as Java, Smalltalk and C++, and conventional procedural programming languages such as “C” or similar programming languages. The program code can be executed entirely on the user's computer, partially on the user's computer, as an independent software package, partially on the user's computer and partially on a remote computer, or entirely on a remote computer or a server. In cases involving a remote computer, the remote computer can be connected to the user's computer through any type of network (including the local area network (LAN) or the wide area network (WAN)), or can be connected to an external computer (e.g., using an Internet service provider to establish a connection via the Internet).

The flow diagrams and block diagrams in the accompanying figures illustrate possible architectures, functions and operations of the system, method and computer program product according to various embodiments of the present disclosure. In this regard, each block in the flow diagrams or block diagrams may represent a module, program segment, or part of code that contains one or more executable instructions for implementing specified logical functions. It should also be noted that, in some alternative implementations, the functions labeled in the blocks may occur in an order different from that indicated in the figures. For example, two blocks presented consecutively may in fact be executed substantially concurrently, or they may sometimes be executed in reverse order, depending on the functions involved. It should also be noted that each block in the block diagrams and/or flow diagrams, as well as combinations of the blocks in the block diagrams and/or flow diagrams, can be implemented using a specialized hardware-based system that performs specified functions or operations, or using a combination of dedicated hardware and computer instructions.

The units described in the embodiments of the present disclosure can be implemented through software or hardware. The name of a unit does not inherently limit the unit itself under certain circumstances. For example, “a first acquisition unit” may also be described as “a unit acquiring at least two Internet Protocol (IP) addresses”.

The functions described above in this document can be executed, at least in part, by one or more hardware logic components. By way of non-limiting examples, exemplary hardware logic components that can be used include: Field-Programmable Gate Arrays (FPGAs), Application-Specific Integrated Circuits (ASICs), Application-Specific Standard Products (ASSPs), Systems-on-Chip (SOCs), Complex Programmable Logic Devices (CPLDs), and the like.

In the context of the present disclosure, the machine-readable medium may be a tangible medium, which can contain or store a program for use by or in connection with an instruction execution system, apparatus or device. The machine-readable medium may be a machine-readable signal medium or a machine-readable storage medium. The machine-readable medium may include but is not limited to an electronic, magnetic, optical, electromagnetic, infrared, or semiconductor system, apparatus or device, or any suitable combination thereof.

The above description merely sets forth preferred embodiments of the present disclosure and explains the applied technical principles. Those skilled in the art should understand that the scope of the disclosure herein is not limited to the technical solutions formed by specific combinations of the above technical features, but shall also cover other technical solutions formed by any combination of the above technical features or their equivalent features without departing from the disclosed concept. For example, the technical solutions formed by replacing the above features with the technical features disclosed (but not limited) in the present disclosure that serve similar functions are also covered.

Furthermore, although the operations are depicted in a specific order, this should not be construed as requiring these operations to be performed in the shown specific order or in sequential order. Under certain circumstances, multitasking and parallel processing may be advantageous. Similarly, while several specific implementation details are included in the discussion above, these should not be interpreted as limitations on the scope of the present disclosure. Certain features described in the context of separate embodiments may also be implemented in combination within a single embodiment. Conversely, various features described in the context of a single embodiment may also be implemented individually or in any suitable sub-combination across multiple embodiments.

Although the subject matter has been described in language specific to structural features and/or methodological acts, it should be understood that the subject matter defined in the appended claims is not necessarily limited to the specific features or acts described above. Rather, the specific features and acts described above are merely exemplary forms of implementing the claims.

1. A media data processing method, comprising:
receiving, through a first server, a trigger request sent by a client after triggering any effect item for an image to be processed, creating, through the first server, an effect processing task, and performing pre-processing on the effect processing task and performing a judgement of a task execution condition;
adding, through the first server, the effect processing task into a cache list readable by a second server after determining that the task execution condition is met based on a pre-processing result of the effect processing task; and
accessing, through the second server, a processing server that performs effect processing, and transmitting the effect processing task obtained from the cache list to the processing server.

2. The method according to claim 1, wherein the performing pre-processing on the effect processing task and performing a judgement of a task execution condition comprises:
determining a target pre-processing item corresponding to the effect processing task from pre-processing items that are pre-configured and performing processing of the target pre-processing item, wherein the pre-processing items are pre-configured on the first server and the pre-processing items comprises: processing model determination, processing permission determination, recognition of an image to be processed, format conversion of an image to be processed, and configuration of processing completion notification; and
determining whether the effect processing task meets the task execution condition according to a pre-processing result of the target pre-processing item.

3. The method according to claim 2, wherein the determining whether the effect processing task meets the task execution condition according to a pre-processing result of the target pre-processing item comprises:
when the target pre-processing item comprises the processing permission determination and the recognition of an image to be processed, in response to a corresponding pre-processing result being that processing is allowed and image recognition is passed, determining that the effect processing task meets the task execution condition; and
when the target pre-processing item comprises the processing permission determination or the recognition of an image to be processed, in response to the pre-processing result being that processing is allowed or image recognition is passed, determining that the effect processing task meets the task execution condition.

4. The method according to claim 1, further comprising:
calling a matching processing model according to a processing model configuration parameter determined in the pre-processing to process the effect processing task through the processing server, and saving a task processing result;
performing post-processing on the task processing result read according to a preset post-processing strategy through the second server, and recording the task processing result that is post-processed into a data center; and
feeding the task processing result obtained from the data center back to the client through the first server; or, sending a processing completion notification to the client, and feeding the task processing result obtained from the data center back to the client after receiving a view request from the client.

5. The method according to claim 4, wherein the feeding the task processing result obtained from the data center back to the client comprises:
obtaining a task processing result corresponding to the effect processing task from the data center, encrypting the task processing result, and feeding an encrypted processing result back to the client; and
after receiving a decryption request for the encrypted processing result from the client, in response to determining that the client meets a decryption permission, calling an independent decryption interface corresponding to the encrypted processing result to perform decryption, and transmitting a decrypted decryption result back to the client.

6. The method according to claim 4, further comprising:
uploading, through the first server, the task processing result obtained from the data center to an image processing platform that is deployed through the first server, obtaining upload information, accessing the image processing platform based on the upload information, receiving a secondary processing result obtained after the image processing platform performs secondary processing on the task processing result, and transmitting the secondary processing result back to the client.

7. The method according to claim 1, further comprising:
receiving, through the first server, an effect query task sent by the client after creating the effect processing task through the first server, and transmitting the effect query task to the second server;
sending, through the second server, a processing progress query request to the processing server based on the effect query task received receiving a progress query result fed back from the processing server and organizing the progress query result into visual query information; and
feeding the visual query information back to the client through the first server for presentation.

8. The method according to claim 1, further comprising:
receiving, through the first server, an effect cancellation task sent by the client after creating the effect processing task through the first server, and transmitting the effect cancellation task to the second server;
transmitting the effect cancellation task to the processing server through the second server, receiving a response result for the effect cancellation task from the processing server and transmitting the response result back to the first server; and
transmitting the response result back to the client through the first server so that the client exits presentation state of effect processing according to the response result.

9. The method according to claim 1, further comprising:
summarizing, through the first server, effect processing tasks received within a set time period, and determining a total number of triggering times for effect items associated with the effect processing tasks within the set time period; and
marking an effect item of which a total number of triggering times is higher than a set threshold as a hotspot effect item through the first server.

10. A media data processing system, comprising: a client, a first server, a second server and a processing server, wherein
the first server is configured to receive a trigger request sent by a client after triggering any effect item for an image to be processed, create an effect processing task, and perform pre-processing on the effect processing task, and perform a judgement of a task execution condition;
the first server is further configured to add the effect processing task into a cache list readable by a second server after determining that the task execution condition is met based on a pre-processing result of the effect processing task; and
the second server is configured to access a processing server that performs effect processing, and transmitting the effect processing task obtained from the cache list to the processing server.

11. An electronic device, comprising:
one or more processors; and
a storage apparatus, configured to store one or more programs;
wherein when the one or more programs are executed by the one or more processors, the one or more processors are caused to implement a media data processing method, and the method comprises:
receiving, through a first server, a trigger request sent by a client after triggering any effect item for an image to be processed, creating, through the first server, an effect processing task, and performing pre-processing on the effect processing task and performing a judgement of a task execution condition;
adding, through the first server, the effect processing task into a cache list readable by a second server after determining that the task execution condition is met based on a pre-processing result of the effect processing task; and
accessing, through the second server, a processing server that performs effect processing, and transmitting the effect processing task obtained from the cache list to the processing server.

12. The electronic device according to claim 11, wherein the performing pre-processing on the effect processing task and performing a judgement of a task execution condition comprises:
determining a target pre-processing item corresponding to the effect processing task from pre-processing items that are pre-configured and performing processing of the target pre-processing item, wherein the pre-processing items are pre-configured on the first server and the pre-processing items comprises: processing model determination, processing permission determination, recognition of an image to be processed, format conversion of an image to be processed, and configuration of processing completion notification; and
determining whether the effect processing task meets the task execution condition according to a pre-processing result of the target pre-processing item.

13. The electronic device according to claim 12, wherein the determining whether the effect processing task meets the task execution condition according to a pre-processing result of the target pre-processing item comprises:
when the target pre-processing item comprises the processing permission determination and the recognition of an image to be processed, in response to a corresponding pre-processing result being that processing is allowed and image recognition is passed, determining that the effect processing task meets the task execution condition; and
when the target pre-processing item comprises the processing permission determination or the recognition of an image to be processed, in response to the pre-processing result being that processing is allowed or image recognition is passed, determining that the effect processing task meets the task execution condition.

14. The electronic device according to claim 11, wherein the method further comprises:
calling a matching processing model according to a processing model configuration parameter determined in the pre-processing to process the effect processing task through the processing server, and saving a task processing result;
performing post-processing on the task processing result read according to a preset post-processing strategy through the second server, and recording the task processing result that is post-processed into a data center; and
feeding the task processing result obtained from the data center back to the client through the first server; or, sending a processing completion notification to the client, and feeding the task processing result obtained from the data center back to the client after receiving a view request from the client.

15. The electronic device according to claim 14, wherein the feeding the task processing result obtained from the data center back to the client comprises:
obtaining a task processing result corresponding to the effect processing task from the data center, encrypting the task processing result, and feeding an encrypted processing result back to the client; and
after receiving a decryption request for the encrypted processing result from the client, in response to determining that the client meets a decryption permission, calling an independent decryption interface corresponding to the encrypted processing result to perform decryption, and transmitting a decrypted decryption result back to the client.

16. The electronic device according to claim 14, wherein the method further comprises:
uploading, through the first server, the task processing result obtained from the data center to an image processing platform that is deployed through the first server, obtaining upload information, accessing the image processing platform based on the upload information, receiving a secondary processing result obtained after the image processing platform performs secondary processing on the task processing result, and transmitting the secondary processing result back to the client.

17. The electronic device according to claim 11, wherein the method further comprises:
receiving, through the first server, an effect query task sent by the client after creating the effect processing task through the first server, and transmitting the effect query task to the second server;
sending, through the second server, a processing progress query request to the processing server based on the effect query task received receiving a progress query result fed back from the processing server and organizing the progress query result into visual query information; and
feeding the visual query information back to the client through the first server for presentation.

18. The electronic device according to claim 11, wherein the method further comprises:
receiving, through the first server, an effect cancellation task sent by the client after creating the effect processing task through the first server, and transmitting the effect cancellation task to the second server;
transmitting the effect cancellation task to the processing server through the second server, receiving a response result for the effect cancellation task from the processing server and transmitting the response result back to the first server; and
transmitting the response result back to the client through the first server so that the client exits presentation state of effect processing according to the response result.

19. The electronic device according to claim 11, wherein the method further comprises:
summarizing, through the first server, effect processing tasks received within a set time period, and determining a total number of triggering times for effect items associated with the effect processing tasks within the set time period; and
marking an effect item of which a total number of triggering times is higher than a set threshold as a hotspot effect item through the first server.

20. A non-transitory computer-readable storage medium having computer programs stored thereon, wherein when the computer programs are executed by a processor, the method according to claim 1 is implemented.
